(19) United States
(12) Patent Application Publication
(10) Pub. No.: US 2010/0206802 A1
(43) Pub. Date: Aug. 19, 2010

(54) WELDED STRUCTURE OF SYNTHETIC RESIN MESH, WOVEN FABRIC, KNITTED FABRIC, AND NON-WOVEN CLOTH; FUEL FILTER BODY; AND WELDING METHOD

(75) Inventors: Hiroji Sato, Kanagawa (JP); Nobuyuki Oikawa, Kanagawa (JP)

Correspondence Address: KANESAKA BERNER AND PARTNERS LLP, 1700 DIAGONAL RD, SUITE 310, ALEXANDRIA, VA, 22314-2848, US

(73) Assignee: NIFCO INC., YOKOHAMA-SHI, KANAGAWA (JP)

(21) Appl. No.: 12/733,308

(22) PCT Filed: Aug. 26, 2008
(86) PCT No.: PCT/JP2008/065188

§ 371 Date: Mar. 30, 2010

(30) Foreign Application Priority Data
Aug. 31, 2007 (JP) 2007-226217

(51) Int. Cl. B01D 29/11; B32B 3/30; B29C 65/08

(52) U.S. Cl. 210/490; 428/172; 156/73.1

(57) ABSTRACT

Two or more sheets of one or more kinds of thermally weldable synthetic resin mesh, woven fabric, knitted fabric, and non-woven cloth are overlaid, and each of the overlaid sheets is welded together so that a prescribed protuberance of molten resin produced when press-welding along the welded part is formed toward a side of the welded part.

### TECHNICAL FIELD

This invention relates to a welded structure or welding method that is useful when making various kinds of products by overlaying and welding together two or more sheets of one or more kinds of thermally weldable synthetic resin mesh, woven fabric, knitted fabric, and non-woven cloth, as well as a fuel filter body that is constituted by applying this structure or method.

### BACKGROUND ART

In the case when overlaying two or more sheets 1, 1, . . . of one or more kinds of thermally weldable synthetic resin mesh, woven fabric, knitted fabric, and non-woven cloth and press-welding by taking between a pair of welding jigs 5, 5 (FIG. 5), molten resin produced during this welding is pressed out irregularly as so-called burrs 3′ toward a side of the formed welded part and remains on the surface of the product (FIG. 6). The task of removing such burrs 3′ therefore becomes unavoidable. Also, when removing such burrs 3′, scars from the removed burrs 3′ may remain, and pinholes may be produced in places where burrs 3′ were present, and these were matters requiring special considerations.

### DISCLOSURE OF THE INVENTION

### Problem to Be Solved by the Invention

The main feature to be solved by this invention is to make it possible to adequately press-weld such synthetic resin woven fabrics, and the like, without causing a problem of burrs.

### Means for Solving the Problem

In order to solve said problem, in this invention, a welded structure of synthetic resin mesh, woven fabric, knitted fabric, and non-woven cloth is made by overlaying two or more sheets of one or more kinds of thermally weldable synthetic resin mesh, woven fabric, knitted fabric, and non-woven cloth, and welding together each of the overlaid sheets so that a prescribed protuberance of molten resin produced when press-welding along the welded part is formed toward a side of the welded part.

Molten resin may be pressed out from the welded part during such press-welding, but in such welded structure, because a prescribed protuberance is formed toward a side of the welded part by this molten resin, the molten resin does not appear irregularly as so-called burrs on the surface of the product created by such welding in this place where the protuberance is formed, and the design characteristics of the created product are not impaired. Also, it is different from conventional press-welding in that there is no need to remove the burrs resulting from said molten resin on the side of the place where the protuberance is formed. Furthermore, a prescribed “stiffness” or rigidity can be given to the place where the welded part is formed on the created product.

Also, in this invention, a fuel filter body, being a bag-form filter body provided on a fuel intake port so as to connect through an internal space, is made by overlaying two or more sheets of one or more kinds of thermally weldable synthetic resin mesh, woven fabric, knitted fabric, and non-woven cloth as filter material, and welding together each of the overlaid sheets so that a prescribed protuberance of molten resin produced when press-welding along the welded part is formed toward a side of the welded part, and making into a bag form.

Molten resin may be pressed out from the welded part during such press-welding, but in such filter body, because a prescribed protuberance is formed toward a side of the welded part by this molten resin, the molten resin does not appear irregularly as so-called burrs on the surface of the filter body created by such welding in this place where the protuberance is formed, and the design characteristics of the created filter body are not impaired. Also, it is different from conventional press-welding in that there is no need to remove the burrs resulting from said molten resin on the side of the place where the protuberance is formed. Furthermore, a prescribed “stiffness” or rigidity can be given to the created filter body by such protuberance and the shape of the filter body can be well formed.

Also, in order to solve said problem, in this invention, a method for performing welding of said welded structure or fuel filter body by ultrasonic welding or high-frequency welding is such that:

a step part is formed on a pushing part of at least one of a pair of welding jigs that are pushed together taking each of the overlaid sheets in between, and the prescribed protuberance is formed by allowing molten resin produced when press-welding to escape from this step part. By this, the prescribed protuberance following the welded part can be formed adequately.

### EFFECT OF THE INVENTION

According to the welded structure or welding method of this invention, thermally weldable woven fabric, and the like, can be layered or connected together adequately by press-welding without causing a problem of burrs.

Also, a fuel filter body of this invention can be created adequately by press-welding without causing a problem of burrs, and the shape of the filter body can be well formed by the prescribed uplifted edge part.

### BRIEF DESCRIPTION OF THE DRAWINGS

FIG. 1 is a drawing in sectional view of a filter device,

FIG. 2 is a drawing in perspective view of the same,

FIG. 3 is a drawing in sectional view of a pair of welding jigs,

FIG. 4 is a drawing in sectional view of the main parts of the welded structure,

FIG. 5 is a drawing in sectional view showing a conventional example, and

FIG. 6 is a drawing in sectional view showing a conventional example.

### PREFERRED EMBODIMENT OF THE INVENTION

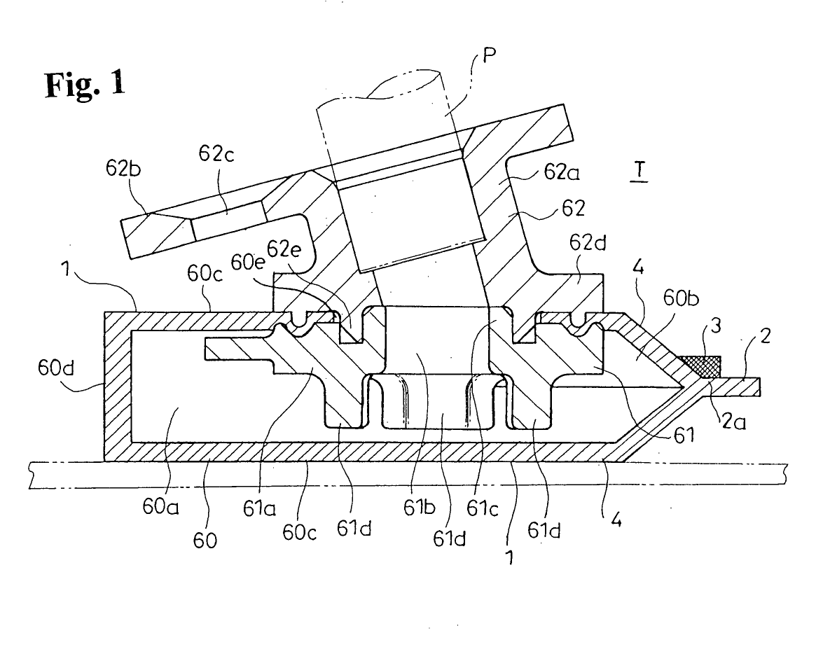

A preferred embodiment of this invention is explained below with reference to FIG. 1 to FIG. 4.

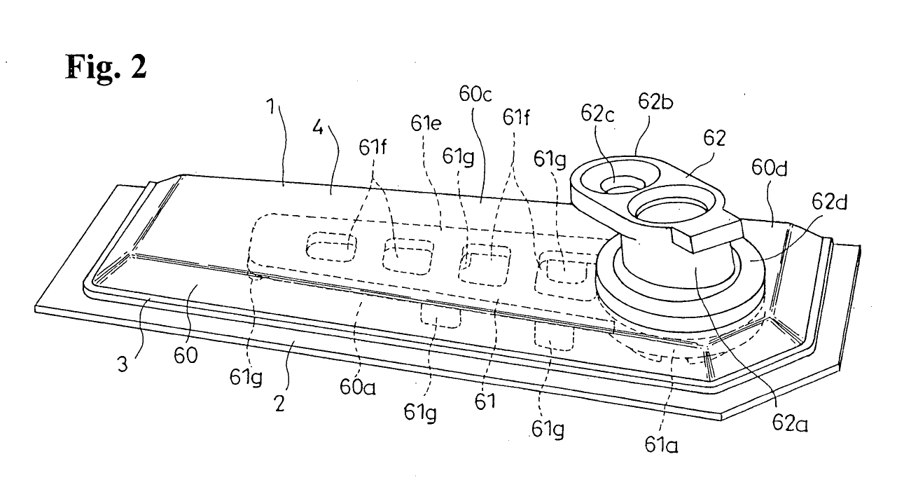

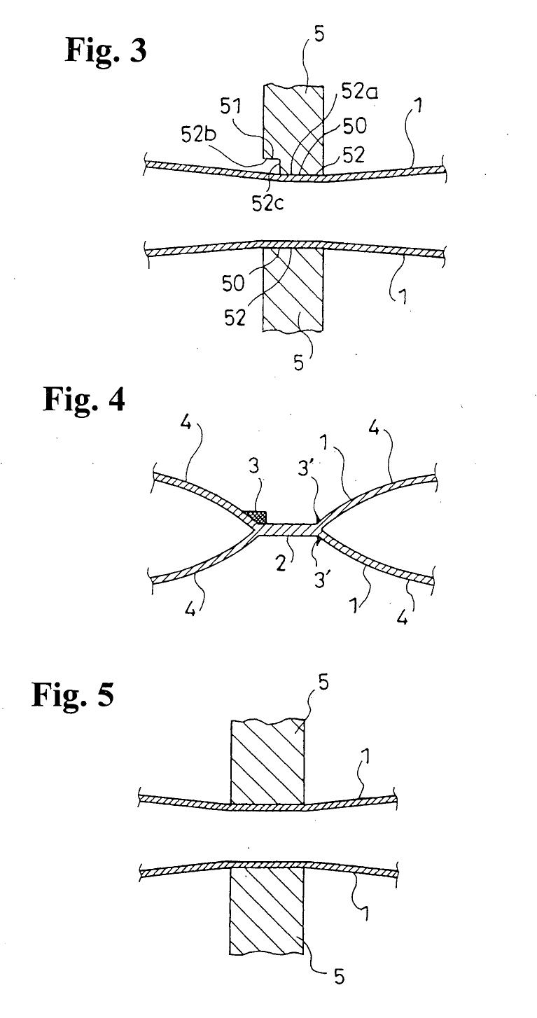

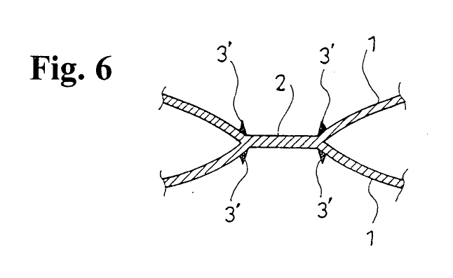

Here, FIG. 1 shows a sectional view of the main parts of a filter device 6 having a filter body 60 constituted by applying the welded structure of the embodiment, and FIG. 2 shows a perspective view of such filter device 6. Also, FIG. 3 shows an example of the constitution of a pair of welding jigs 5, 5 for obtaining such welded structure, and FIG. 4 shows a sectional view of the main parts of a welded structure obtained by using the welding jigs 5 in FIG. 3.

The welded structure of this embodiment is useful when making various kinds of products by overlaying and welding together two or more sheets of one or more kinds of thermally weldable synthetic resin mesh, woven fabric, knitted fabric, and non-woven cloth.

Such welding is performed, for example, in order to maintain a layered state in the case when creating a layered body from such mesh, or in order to connect together two sheets of such mesh, and the like, by their edges.

Such welded structure is made by welding together each of the sheets thus overlaid so that a prescribed protuberance 3 of molten resin produced when press-welding along the welded part 2 is formed toward a side of this welded part 2.

What is intended as such press-welding is that which forms a welded part 2 that is positioned lower than a non-welded part 4 by simultaneously pressing and heating using a pair of welding jigs 5, 5 (hot plates, hone and anvil, electrodes, and the like), such as by welding with hot plates, ultrasonic welding, and high-frequency welding.

Molten resin may be pressed out from the welded part 2 during such press-welding, but in such welded structure, because a prescribed protuberance 3 is formed toward a side of the welded part 2 by this molten resin, the molten resin does not appear irregularly as so-called burrs 3′ on the surface of the product created by such welding in this place where the protuberance 3 is formed, and the design characteristics of the created product are not impaired. Also, it is different from conventional press-welding in that there is no need to remove the burrs 3′ resulting from said molten resin on the side of the place where the protuberance 3 is formed. Furthermore, a prescribed “stiffness” or rigidity can be given to the place where the welded part 2 is formed on the created product.

When such press-welding is performed by ultrasonic welding or high-frequency welding, a step part 51 is formed on a pushing part 50 of at least one of a pair of welding jigs 5, 5 that are pushed together taking each of the overlaid sheets (leaves) 1, 1, . . . in between (FIG. 3), and the prescribed protuberance 3 is formed by allowing molten resin produced when press-welding to escape from this step part 51 (FIG. 4).

In the example shown in FIG. 3, of the respective opposing faces 52 of the pair of welding jigs 5, 5, the opposing face 52 of one of the welding jigs 5 is constituted in two stages with an upper face 52a and a lower face 52b and a step face 52c between the two faces 52a, 52b. Also, each of the overlaid sheets 1, 1, . . . is pressed between the opposing face 52 of the other welding jig and upper face 52a of the one welding jig, and molten resin pressed out from this pressed place escapes to the step part 51 formed by the step face 52c and the lower face 52b and is hardened in shape in this step part 51. By this, the prescribed protuberance 3 following the welded part 2 can be formed adequately.

If the opposing face 52 of the one welding jig of the pair of welding jigs 5, 5 is constituted in a point form having an upper face 52a and lower faces 52b respectively on the left and right of this upper face 52a, then prescribed uplifted edge parts 3 following the formed welded part 2 can be formed respectively on both sides, left and right, of the welded part 2. Also, if step parts 51 are formed respectively on both opposing faces 52 of the pair of welding jigs 5, 5, then prescribed uplifted edge parts 3 following the formed welded part 2 can be formed respectively on the top and the bottom of the created product.

FIG. 1 and FIG. 2 show an example in which a bag-form filter body 60 provided on a fuel intake port P on the inside T of a fuel tank of an automobile or two-wheeled vehicle so as to connect through an internal space 60a was created using said welded structure or welding method.

Such filter body 60 is made by overlaying two or more sheets of one or more kinds of thermally weldable synthetic resin mesh, woven fabric, knitted fabric, and non-woven cloth as filter material, and welding together each of the overlaid sheets 1, 1, . . . so that a prescribed protuberance 3 of molten resin produced when press-welding along the welded part 2 is formed toward a side of the welded part 2, and making into a bag form.

Molten resin may be pressed out from the welded part 2 during such press-welding, but in such filter body 60, because a prescribed protuberance 3 is formed toward a side of the welded part 2 by this molten resin, the molten resin does not appear irregularly as so-called burrs 3′ on the surface of the filter body 60 created by such welding in this place where the protuberance 3 is formed, and the design characteristics of the created filter body 60 are not impaired. Also, it is different from conventional press-welding in that there is no need to remove the burrs 3′ resulting from said molten resin on the side of the place where the protuberance 3 is formed. Furthermore, a prescribed “stiffness” or rigidity can be given to the created filter body 60 by such protuberance 3 and the shape of the filter body 60 can be well formed.

In this case, it is preferable that the filter body 60 be made by forming the prescribed protuberance 3 toward the inner side 2a of the welded part 2 positioned on the inside 60b of the bag (FIG. 1/for example, formed so that the left side in FIG. 4 is taken as the inside 60b of the bag), and doing final shaping by cutting applied within the width of the welded part 2. This is because irregular burrs 3′ from the molten resin pressed out during press-welding may appear on the outer side of such welded part 2 because an protuberance 3 is not formed, but the filter body 60 can be made by removing the parts where these burrs 3′ appeared by said cutting.

Such filter body 60 is attached to the fuel intake port P on the inside T of the fuel tank of an automobile or two-wheeled vehicle so that water and foreign matter are not allowed into the fuel sent to the side of the internal combustion engine through such fuel intake port P.

Typically, such filter body 60 is to be attached to the fuel intake port P of an intake pipe having this fuel intake port P on the inside T of the fuel tank.

Also, sending of fuel to the side of the internal combustion engine through such fuel intake port P is accomplished by a fuel pump disposed on the inside T of the fuel tank or a fuel pump disposed on the outside of the fuel tank.

In the illustrated example, such filter body 60 constitutes a filter device 6 by being combined with a space-forming member 61 and a connector 62.

The filter body 60 is constituted by sheet-form synthetic resin mesh (so-called extruded mesh manufactured by extrusion molding, and the like), woven fabric, knitted fabric, and non-woven cloth to function as filter materials 60c. Typically, a bag-form filter body 60 is formed from such filter materials 60c by overlaying two or more sheets of one or more kinds of these sheet-form filter materials 60c and folding these in two in such state, and applying band-form welding connecting one end of the band and the other end respectively to the folded side 60d so as to form an enclosed space within the folded side 60d. Or, a first group of filter materials 60c and a second group of filter materials 60c respectively constituted by two or more sheets of one or more kinds of sheet-form filter materials 60c are overlaid with the sides to be positioned on the inside of the filter body 60 facing each other, and then encircling band-form welding is applied to these, whereby a bag-form filter body 60 having the inside of the applied welded part 2 as an internal space 60a is formed. The welded filter materials 60c are cut within the width of the welded part 2 and the shape is made well formed. The space-forming member 61 is disposed between the place where welding is applied and the folded side 60d, or inside the place where encircling band-form welding is applied, before such weld is applied, and is held inside the filter body 60 by the weld. Typically, a filter material 60c of mesh or woven fabric having an oil-water separating function is disposed on the outside of the filter body 60, and one or more sheets of filter material 60c made of non-woven cloth for removing dirt and dust are disposed on the inside.

The space-forming member 61 is made of synthetic resin, and is placed inside said filter body 60 to maintain the inflated state of the filter body 60.

In the illustrated example, such space-forming member 61 has a disk-shaped base part 61a, and an elongated part 61e that extends toward the side with one end integrally connected to this base part 61a. A circular pass-through hole 61b is formed in the center of the base part 61a, and a short-dimensional cylinder part 61c having an inner diameter equal to this pass-through hole 61b and having a space inside the cylinder connected through to this pass-through hole 61b is formed on the upper face of the base part 61a. Space-forming projections 61d are formed on the lower face of the base part 61a, whereby fuel filtered and taken inside the filter body 60 is sent into the fuel intake port P through the pass-through hole 61b from between adjacent space-forming projections 61d. The elongated part 61e has a plurality of roughly square pass-through holes 61f, 61f, . . . on a long and slender plate body formed so as to gradually become narrower going from the one end connected to the base part 61a, and space-forming projections 61g projecting outward from the lower face of the elongated part 61e respectively on the left and right of the other end and the middle part and on the left and right between the middle part and the base part 61a. The space-forming projections 61d of the base part 61a and the space-forming projections 61g of the elongated part 61e are constituted so as to have roughly the same dimension of projection.

The connector 62 is made of synthetic resin, and connects through the internal space 60a of said filter body 60 to the fuel intake port P.

In the illustrated example, such connector 62 has a cylindrical main part 62a having both ends of the cylinder open, a connecting ear part 62b formed on the upper end of this cylindrical main part 62a, and a fringe part 62d formed on the lower end of this cylindrical main part 62a. The connecting ear part 62b is provided so as to project outward from the cylindrical main part 62a, and has a fixing hole 62c. The connector 62 and the intake port P are connected by inserting the intake port P inside the cylindrical main part 62a from the upper side of this cylindrical main part 62a. The fringe part 62d is constituted such that the outside edge is circular, and a short-dimensional cylinder part 62e having an encircling upright form and an inner diameter roughly equal to the outer diameter of the short-dimensional cylinder part 61c of the space-forming member 61 is formed on the lower face of the fringe part 62d. The space-forming member 61 and the connector 62 are combined so that the short-dimensional cylinder part 61c of the space-forming member 61 is inserted inside the short-dimensional cylinder part 62e through the pass-through hole 60e formed on the upper end of the filter body 60. The pass-through hole 60e of such filter body 60 is formed on a part of the place to become the upper face of this filter body 60 before said sheet-form filter materials 60c constituting this filter body 60 are made into said bag form. Although not illustrated, it is preferable that such pass-through hole 60e also be formed on a part of the place to become the upper face of the filter body 60, on a group of filter materials 60c constituted by overlaying two or more sheets of one or more kinds of sheet-form filter materials 60c, by forming a ring-form welded part 2 so as to form a prescribed protuberance 3 toward the outer side of this welded part 2, and then applying ring-form cutting within the width of this welded part 2.

The specification, claims, drawings, and abstract of Japanese Patent Application No. 2007-226217 filed on Aug. 31, 2007 are cited in their entirety herein and are incorporated as a disclosure of the specification of the present invention.

1. A welded structure of synthetic resin material comprising:
two or more sheets selected from at least one of thermally weldable synthetic resin mesh, woven fabric, knitted fabric, and non-woven cloth, said sheets being laminated together,
a welding portion of the sheets laminated together, and
a protuberance of molten resin formed at one side of the welding portion produced when press-welding the sheets, said protuberance extending along the welding portion.

2. A fuel filter body with a bag-form, comprising:
two or more sheets selected from at least one of thermally weldable synthetic resin mesh, woven fabric, knitted fabric, and non-woven cloth as filter material, said sheets being laminated together and overlaid to have the bag-form,
a welding portion of the sheets overlaid together to have the bag-form, and
a protuberance of molten resin formed at one side of the welding portion produced when press-welding the sheets, said protuberance extending along the welding portion.

3. The fuel filter body according to claim 2, wherein the protuberance is formed at an inner side of the welding portion.

4. (canceled)

5. A welding method for forming a welded structure, comprising:
laminating two or more sheets selected from at least one of thermally weldable synthetic resin mesh, woven fabric, knitted fabric, and non-woven cloth,
welding the two or more sheets by ultrasonic welding or high-frequency welding, and
pushing the two or more sheets by a pair of welding jigs in between while welding to form a protuberance at one side of the sheets by molten resin produced when press-welding and escaped to a step part of one of the welding jigs.

6. A welding method according to claim 5, wherein the two or more sheets are further laminated together, and edge portions of the two or more sheets laminated together are welded to form a bag shape for a fuel filter.
